(19) United States
(12) Patent Application Publication
(10) Pub. No.: US 2025/0209282 A1
(43) Pub. Date: Jun. 26, 2025

(54) DATA ADJUSTMENT USING LARGE LANGUAGE MODEL

(71) Applicant: Fujitsu Limited, Kawasaki-shi (JP)

(72) Inventors: Lei LIU, Sunnyvale, CA (US); Sou HASEGAWA, Mountain View, CA (US); Wei-Peng CHEN, Fremont, CA (US)

(73) Assignee: Fujitsu Limited, Kawasaki-shi (JP)

(21) Appl. No.: 18/393,472

(22) Filed: Dec. 21, 2023

(51) Int. Cl. G06F 40/40; G06F 16/35

(52) U.S. Cl. CPC G06F 40/40; G06F 16/35

(57) ABSTRACT

A method may include accessing a dataset including multiple data subsets, each of the data subsets corresponding to a feature of the dataset. Data in the data subsets may be analyzed to determine a characteristic of the data. In addition, a prompt template may be selected from prompt templates for the one of the data subsets based on the determined characteristic of the data. Prompts may be generated using the prompt template and the data from the one of the data subsets. The prompts may be provided to an LLM. The prompts may command the LLM to perform one or more operations with respect to the data of the one of the data subsets. One or more additional data subsets may be created for the dataset based on response of the LLM. Each of the one or more additional data subsets may correspond to a new feature of the dataset.

### FIELD

The present disclosure generally relates to using large language models to adjust data for a machine learning model.

### BACKGROUND

Machine learning (ML) models are trained using a training dataset. Quality of the training dataset affects the accuracy and the reality of the predictions made by the ML models. For instance, the training dataset may define the prediction patterns of the ML models. A well-diversified and representative training dataset that includes various scenarios and features may allow the ML models to make valid predictions on different and various input data.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

According to an aspect of an embodiment, a method may include accessing a dataset including multiple data subsets, each of the data subsets corresponding to a feature of the dataset. Data in the one or the data subsets may be analyzed to determine a characteristic of the data. In addition, a prompt template may be selected from multiple prompt templates for the one of the data subsets based on the determined characteristic of the data of the one of the data subsets. Multiple large language model prompts may be generated using the prompt template and the data from the one of the data subsets. The multiple large language model prompts may be provided to a large language model. The multiple large language model prompts may command the large language model to perform one or more operations with respect to the data of the one of the data subsets. One or more additional data subsets may be created for the dataset based on response of the large language model. Each of the one or more additional data subsets may correspond to a new feature of the dataset.

The object and advantages of the embodiments will be realized and achieved at least by the elements, features, and combinations particularly pointed out in the claims. It is to be understood that both the foregoing general description and the following detailed description are explanatory and are not restrictive of the invention, as claimed.

### BRIEF DESCRIPTION OF THE DRAWINGS

Example embodiments will be described and explained with additional specificity and detail through the accompanying drawings in which:

FIG. 1A illustrates an example system to train a machine learning model;

FIG. 1B illustrates an example system configured to adjust a dataset used to train a machine learning model;

FIG. 1C illustrates another example system configured to adjust a dataset used to train a machine learning model;

FIG. 2 illustrate a flowchart of an example method of adjusting one or more data subsets of a dataset;

FIG. 3 is a flowchart of another example method of adjusting one or more data subsets of a dataset;

FIG. 4 is a flowchart of another example method of adjusting one or more data subsets of a dataset; and

FIG. 5 is an example computing system, all in accordance with one or more embodiments of the present disclosure.

### DETAILED DESCRIPTION

Machine learning models may be trained using a training dataset to make predictions. The training dataset may include training instances or individual data points used to train the ML model. Individual data points may correspond to features and a target variable that the ML model may be designed to predict. The features may define the characteristics of the data that the ML model may use to make predictions. The features may include various data types such as numerical, categorical, text-based, among others.

In some instances, the training dataset may be represented in different formats suitable for the ML models. For instance, the training dataset may be represented in a tabular format having multiple columns and rows. In such instances, the columns may represent features of the training dataset, and the rows may represent individual instances or data points of the features. In some instances, the training dataset may be adjusted such that variability of the features may be improved. For instance, a number of the features or the columns may be increased to improve variability of the training dataset.

Some techniques of adjusting the training dataset may include incorporating additional new information to the existing training dataset. For instance, preexisting data in the training dataset may be analyzed to determine the new information that is related to the preexisting data and the new information may be incorporated to broaden the scope of data included in the training dataset. A variety of different approaches have been used to determine the new information.

For example, in one approach the new information may be determined based on meta-data analysis. For instance, the meta-data describing the information included in the training dataset may be analyzed to determine external information related to the training dataset. The metadata may represent different characteristics of the training dataset such as table name, column, name, data type, etc. A directory including available reference datasets may be searched using the characteristics determined from the metadata to be added to the training dataset.

In another approach, the training dataset may be compared against a database including reference datasets to identify similarly related data. The comparison may be done based on a similarity metric. The similarity metric may be calculated based on semantic similarity between two or more datasets. Such approaches may determine external data related to the training dataset to broaden the scope of the training dataset. However, such approaches may be limited in the range of the new information that may be added. For instance, the scope of external information may be limited to information present in the reference datasets. Additionally, such approaches may only add new information to the training dataset rather than improving the preexisting data in the training dataset.

The present disclosure may relate to, among others, a system and a method related to adjusting a training dataset. The adjustment of the training dataset may enrich the training dataset by enhancing, such as by adding, additional features to the training dataset.

In some embodiments, the adjustment of the training dataset may be performed using a large language model. In these and other embodiments, information generated by the large language model may be used to add external information to the training dataset as well as improving the data already existing in the training dataset. In some embodiments, a feature type inference may be performed with respect to the training dataset. For instance, different types of data in the training dataset may be identified and labeled. For example, in instances in which the training dataset is represented as a tabular dataset, different columns may represent different types of data. In such instances, a feature type inference process may determine and accordingly label types of each column or subset of the training dataset. Based on the different types of data, various large language model prompts may be generated and provided to the large language model. The responses from the large language model may be used to adjust the training dataset by improving existing data and/or adding additional data. Adjusting the training dataset using the large language model may improve scope and comprehensiveness of the training dataset. As a result, the machine learning models generated using the training dataset may be improved. For example, the machine learning models may be more robust and more accurately predict a target feature.

Embodiments of the present disclosure are explained with reference to the accompanying figures.

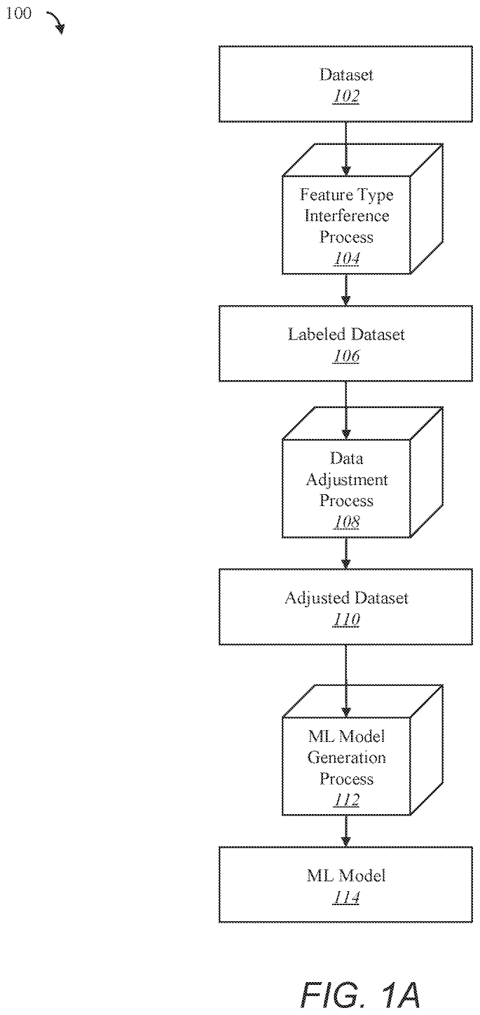

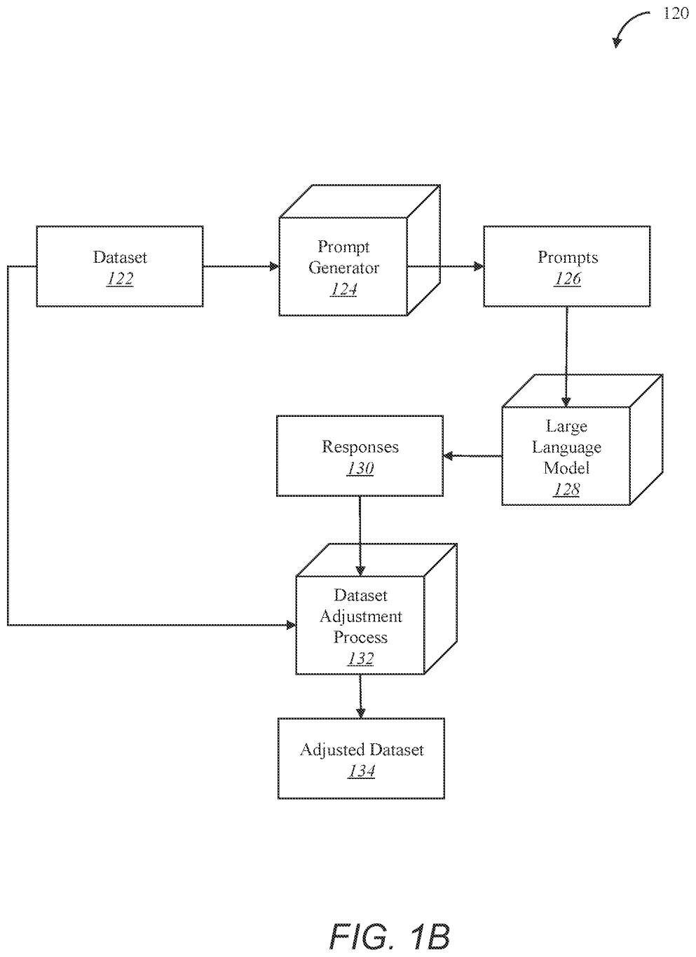

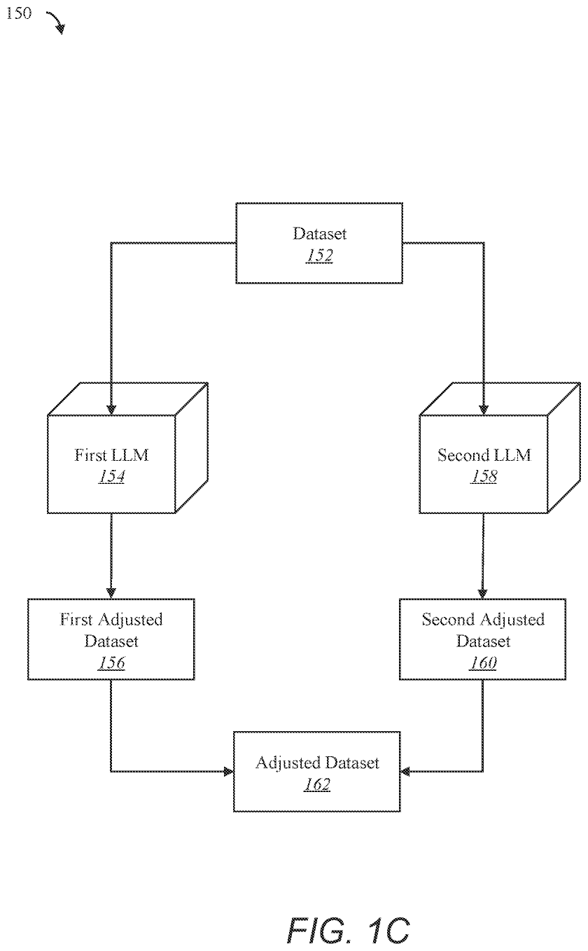

FIG. 1A illustrates an example system 100 configured for machine learning training, in accordance with one or more embodiments of the present disclosure. In some embodiments, the system 100 may include a features type interference (FTI) process 104, a data adjustment process 108, and a machine learning (ML) model generation process 112. In general, the system 100 may be configured to train the ML model 114. In some embodiments, the system 100 may be configured to train the ML model 114 using a dataset 102 that may be adjusted or enhanced to improve the training of the ML model 114.

In some embodiments, the FTI process 104 may obtain the dataset 102. In some embodiments, the dataset 102 may be a training dataset that may be used to train the ML model 114. For instance, the dataset 102 may include data suitable to train the ML model 114 to perform one or more operations to generate predictions. For instance, the dataset 102 may include data corresponding to features and to a target feature that may be used to train the ML model 114.

In some embodiments, the dataset 102 may include one or more data subsets that may correspond to one or more features. In these and other embodiments, the one or more features may include different types of features. The FTI process 104 may analyze the data in the one or more data subsets to identify the different types of features included in the one or more data subsets. The one or more data subsets may be labeled accordingly to indicate the types of features included in the one or more data subsets. For instance, the FTI process 104 may generate a labeled dataset 106 which may correspond to the dataset 102 with feature labels corresponding to the data subsets of the dataset 102. In some instances, the different data types may include categorical variables (e.g., textual features), identifier (ID) style features (e.g., numerical IDs, alphanumeric codes, etc.), among others. For example, a first data subset may include an address and a second data subset may include an income. The first data subset and the second data subset may not have labels identifying the type of the data. The FTI process labels the first data subset as addresses and the second data subset as income.

In some embodiments, the labeled dataset 106 may be processed by the data adjustment process 108 to generate the adjusted dataset 110. In these and other embodiments, the data adjustment process 108 may include one or more algorithms and/or operations to adjust the scope of the labeled dataset 106. As an example, the dataset 102 may be adjusted such that the scope of the dataset 102 may be broadened.

In some embodiments, the data adjustment process 108 may be configured to command a large language model (LLM) to generate one or more additional features with respect to the labeled dataset 106. The one or more additional features may be used to generate the adjusted dataset 110. For instance, the adjusted dataset 110 may include additional data in addition to the existing data of the dataset 102. In some embodiments, the one or more additional features generated by the LLM may vary based on the types of features corresponding to the one or more data subsets. For example, the one or more additional features may include enhancement of existing data and the addition of external data determined based on the existing data. In some instances, the enhancement to the existing data may include additional grouping or dividing of the existing data such that at least one new feature is generated. The new feature may make a portion of the existing data more distinct within the dataset 102. Contrastingly, the external data may include new data that is not present in the dataset 102 but that may be related to at least one existing feature of the dataset 102.

In some embodiments, the adjusted dataset 110 may be used to train the ML model 114. For instance, the ML model 114 may learn the patterns and/or relationships between the features and the target feature in the adjusted dataset 110, such that the ML model 114 may predict a value for the target feature when given values of the other features. In some embodiments, the ML model 114 may be any type of ML model. For example, the ML model may be a supervised learning model (e.g., regression model, classification model), an unsupervised learning model (e.g., clustering model), a deep learning model (e.g., convolutional neural networks, recurrent neural networks, transformer models), among others.

As indicated, the ML model 114 may be used to predict the values of the target feature. For example, a dataset that includes one or more of the features of the dataset may be provided to the ML model 114. The ML model 114 may predict a value of the target feature based on the values of the one or more features provided. By providing an adjusted dataset, e.g., a dataset with more features, the ML model may more accurately predict the value of the target feature. Thus, adjustment of the dataset 102 may improve the training of ML models and may improve the machine learning technology.

FIG. 1B illustrates an example system 120 configured to adjust a dataset used to train a machine learning model, in accordance with one or more embodiments of the present disclosure. In some embodiments, the system 120 may include a prompt generator 124, an LLM 128, and a dataset adjustment process 132. In some embodiments, the prompt generator 124 may be configured to generate one or more prompts 126 for the LLM 128 based on a dataset 122.

In some embodiments, the dataset 122 may include data that may be used to train an ML model. The dataset 122 may be obtained from any source or constructed using any data compilation technique. The data may include numerical data, character strings that include characters, such as letters, symbols, or other characters, numbers, or a combination of numbers and characters. The data may also include other formats of data.

The data in the dataset 122 may be organized into one or more data subsets. For example, data of the same category may be organized into the same data subset. For example, the data may include address, lot values, lot sizes, and lot improvements. As an example, the data representing the lot values may form part of a data subset. In these and other embodiments, the data of the same category and the grouped in a data subset may be referred to as a feature of the dataset 122. As an example, the dataset 122 may include tabular data that may be arranged in columns and rows. In these and other embodiments, each of the columns may represent a feature of the dataset 122 and each of the rows may include values in one or more of the columns. The values in one of the rows may be associated together. For example, following the previous example, the values for each of the columns in a single row may be associated with the same address.

In some embodiments, the one or more data subsets of the dataset 122 may include various types of features. In such instances, the different types of features may be identified, and the one or more data subsets may be labeled according to associated types of features. In some embodiments, the one or more data subsets may be labeled by an FTI Process. In some embodiments, the operations of the FTI process may be discussed in further detail with respect to the FIT process 104 of FIG. 1A. An example of the FTI process is further described in a U.S. patent application entitled “Data Set Feature Type Inference”, by Sou Hasegawa, Lei Liu, Wei-Peng Chen (Atty. Docket No. F1423.10578US01) filed on Dec. 21, 2023, which is incorporated herein by reference in its entirety.

The system 120 may be configured to adjust the dataset 122 to generate the adjusted dataset 134. The system 120 may adjust the dataset 122 by using the LLM 128 to determine how additional data may be add to the dataset 122 or how to adjust the data in a feature to create additional features.

In some embodiments, the prompt generator 124 may be configured to analyze the dataset 122. Based on the analysis of the dataset 122, the prompt generator 124 may generate the prompts 126 that may be provided to the LLM 128. The prompts 126 may be used by the LLM 128 to determine how to adjust the dataset 122. In some embodiments, the LLM 128 may refer to a sophisticated artificial intelligence system that has been trained on a vast amount of textual data to understand and generate human-like language prompts and responses. The LLM models may be designed to process and comprehend the complexities of natural language, including syntax, semantics, and context. The LLM 128 may comprehend the human language in different forms and produce human-like responses. Additionally, factual knowledge may be retrieved from the LLM due to an associated training methodology. For instance, during pre-training, the LLM models may be exposed to massive amounts of diverse textual data from the internet and other sources, such as articles, books, websites, and various documents that contain factual information. The factual information may be utilized to adjust the dataset in a rational manner.

In some embodiments, the prompt generator 124 may analyze the dataset 122 to determine one or more characteristics of the data of each of the data subsets. For example, the analysis may determine a first characteristic of data of a first data subset and a second characteristic of data of a second data subset. Based on the characteristics of the data of the data subsets, the prompt generator 124 may select one or more data subsets for which a prompt 126 may be generated. In these and other embodiments, the prompt generator 124 may generate the prompts 126 based on the characteristics of the data of the selected data subsets. In these and other embodiments, a different prompt 126 may be generated for different data subsets based on the characteristics of the data in each of the data subsets.

In some embodiments, each of the prompts 126 may further include one or more commands for the LLM 128. The commands may include operations to perform on the data of the selected data subset. In these and other embodiments, different commands may be provided to the LLM 128 for different characteristics of the data of the data subsets and/or the different types of features associated with the data subsets. For instance, different commands may be included in the prompts 126 for textual features and ID-style features. The textual features are features represented using texts in different languages. In some instances, the textual features may include categorical features that take on a limited and fixed number of possible values, representing different categories. The categories may be nominal (e.g., no inherent order) or ordinal (e.g., specific order). For example, nominal categorical features may include different names of schools, countries, colors, among others. Some examples of ordinal categorical features may include sizes (e.g., small, medium, large), school rankings, among others.

In some embodiments, each prompt 126 may be generated to include one more individual values of a data subset of the dataset 122 and one or more commands. The commands may include one or more operations to be performed by the LLM 128 with respect to the individual values of the data subset. As an example, the certain portion may be the values from multiple rows from a single column in the dataset 122.

In some embodiments, the prompts generator 124 may generate the prompts 126 for a set of data from a data subset. For instance, the prompt generator 124 may select a random number of individual values from the data subset. Thus, the set of data may not include all of the individual values from the data subset. For instance, in instances in which the prompts 126 include commands related to determining how to divide character strings into two or more substrings, only the set of data may be used to generate the prompts 126 instead of the entire data subset. Using only the set of data may reduce needed processing time and resources to determine how to divide character strings. In some embodiments, in response to determining how to divide character strings based on the prompts 126. In these and other embodiments, a data division rule may be determined based on responses from the LLM resulting from the prompts. In response to determining the data division rule using the set of data, the data division rule may be applied to the entire data subset.

In some embodiments, the prompt generator 124 may generate the prompts 126 using prompt templates. A prompt template may include a prompt that may include one or more blank fields. The prompt may be a string of words that convey a command for the LLM 128. The blank fields may be completed using data of the data subsets and/or a name of the feature associated with the data subset. For instance, each prompt 126 for a data subset may include the same string of words but may include a different value from the data subset in the blank fields. For example, a prompt template may read as follows: divide [feature] [data value] into meaningful substrings. The [feature] and [data value] may be blank fields in the prompt template. The feature blank field may be filled with the name of the feature associated with the data subset. The data value blank field may be filled with an individual value from the data subset.

In some embodiments, the prompts 126 may command the LLM 128 to perform one or more operations related to the data of the dataset 122. For instance, the prompts 126 may include commanding the LLM 128 to generate additional data with respect to the specific data of the dataset 122 provided to the LLM 128 using the prompts 126. For example, the prompts 126 may command the LLM 128 to divide a value, such as a string, into multiple values. Dividing each of the values of a first data subset into multiple values may result in the first data subset being divided into two or more individual data subsets.

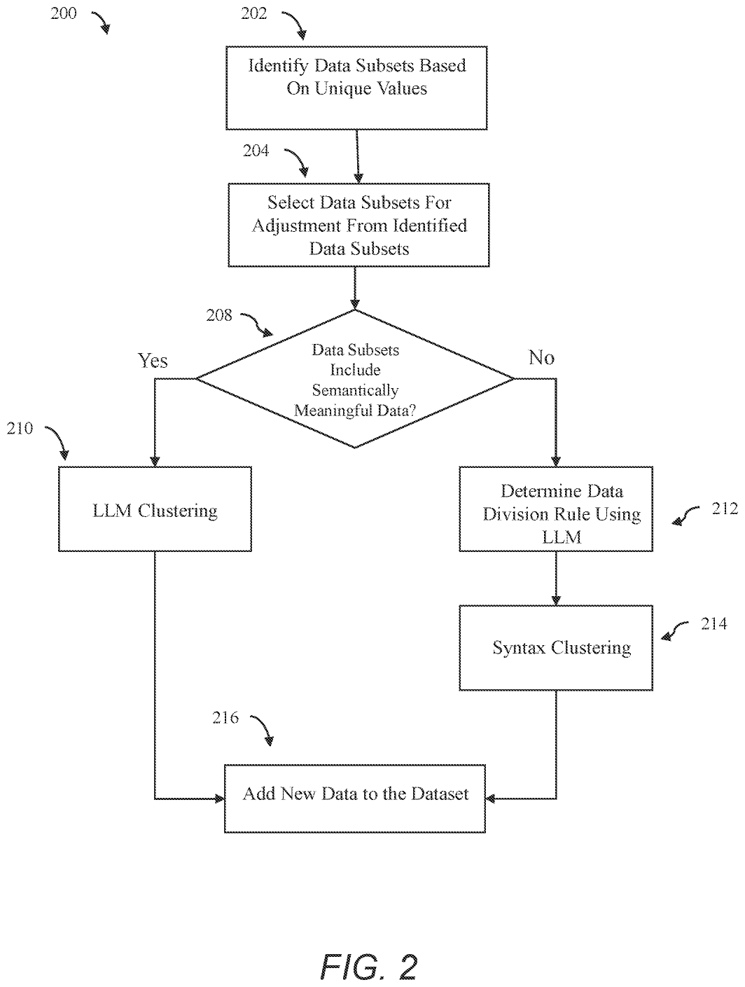

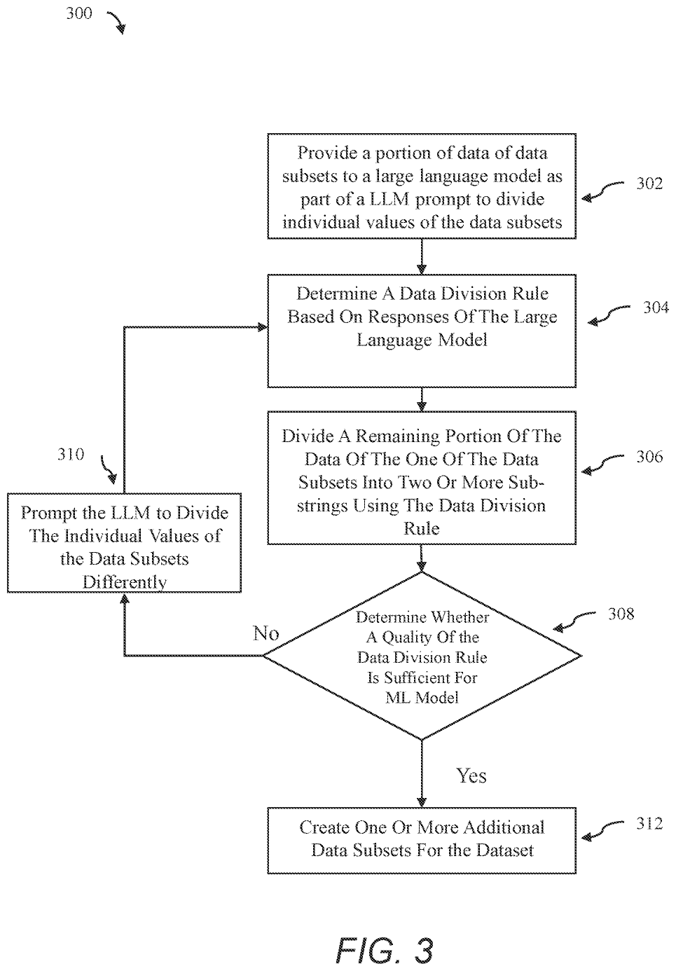

In some embodiments, the prompts 126 may command the LLM 128 to cluster individual values of a data subset into two or more groups. For instance, the individual values may be clustered together into groups based on at least one similarity in the format or meaning of the individual values. Each group may be assigned a cluster ID, and a new data subset may include the cluster ID for each individual value of the data subset. In some embodiments, the enhancement of the existing data may be described in further detail with respect to FIGS. 2 and 3 of the present disclosure.

Additionally or alternatively, in some embodiments, the prompts 126 may command the LLM 128 to determine additional data related to the one or more data subsets of the dataset 122. In some instances, the additional data may include a feature that is not in the dataset 122. For instance, different prompts 126 may be generated for textual features and ID style features. For example, the prompts 126 for ID style features may include the clustering or splitting commands, while the prompts 126 for textual features may include the commands for determining external data.

In some embodiments, the LLM 128 may provide responses 130 based on the prompts 126. For instance, the LLM 128 may perform the one or more operations included in the prompts 126 with respect to the portion of the data subset included in the prompts 126. For instance, the LLM 128 may perform operations such as splitting the data, clustering the data, generating new data, among others.

In some embodiments, the responses 130 may be evaluated. Based on the evaluation of the response, further prompts 126 may be generated. The further prompt may include the response and include the instructions for the LLM 128 to provide another response that is different from the initial response.

In some embodiments, the responses 130 may be used by the data adjustment process 132 to generate the adjusted dataset 134. For instance, the data adjustment process may generate one or more additional data subsets to be included in the dataset 122 based at least on the responses 130. For example, the responses 130 may include additional data generated with respect to one or more data subsets of the dataset 122 based on one or more operations such as splitting, clustering, and generating external information. In such instances, the additional data may be used to build the additional data subsets which may be added to the dataset 122 to generate the adjusted dataset 134. In some embodiments, the additional data subsets may replace an existing data subset. For example, a first data subset may be split into a second data subset and a third data subset. In some instances, the first data subset may be removed from the dataset 122 and the second data subset and the third data subset may be added to the dataset 122.

Modifications, additions, or omissions may be made to the system 120 without departing from the scope of the present disclosure. For example, in some embodiments, the system 120 may include any number of other components that may not be explicitly illustrated or described.

As another example, in some embodiments, a prompt 126 may be used to determine additional characteristics of data. For example, initial characteristics of data may be determined and used to generate one or more prompts 126. The one or more prompts 126 may be provided to the LLM 128 and responses from the LLM 128 may be collected. The responses may assist in determining other characteristics of the data. The other characteristics may be used to generate additional prompts 126 that may be provided to the LLM 128.

As another example, in some embodiments, any number of LLMs may be used to generate the adjusted dataset 134. For example, FIG. 1C illustrates a system configured to adjust a dataset used to train a machine learning model, in accordance with one or more embodiments of the present disclosure. In some embodiments, a dataset 152 may be used to generate one or more prompts to be provided to a first LLM 154 and a second LLM 158. For instance, the dataset 152 may be used to generate a first set of prompts for the first LLM 154 and a second set of prompts for the second LLM 158. In some embodiments, the first set of prompts and the second set of prompts may be generated using a process similar to a process taken to generate the prompts 126 of FIG. 1B.

In some embodiments, the prompts may be divided into two or more groups. For instance, the prompts may be divided based on the types of features associated with data subsets. For example, prompts generated based on textual features may be grouped together into the first set of prompts and prompts generated based on ID-style features may be grouped together into the second set of prompts. In some embodiments, the first set of prompts may be provided to the first LLM 154 and the second set of prompts may be provided to the second LLM 158.

In these and other embodiments, a first adjusted dataset 156 and a second adjusted dataset 160 may be generated based on responses of the first LLM 154 and the second LLM 158, respectively. For instance, the first LLM 154 may generate first responses based on the first set of prompts, and the second LLM 158 may generate second responses based on the second set of prompts. The first responses may be used to determine the first adjusted dataset 156, and the second responses may be used to determine the second adjusted dataset 160.

In some embodiments, the first adjusted dataset 156 may include additional data (e.g., external information) related to the textual features, and the second adjusted dataset 160 may include additional data (e.g., split data) related to the ID-style features. For instance, the first adjusted dataset 156 and the second adjusted dataset 160 may include additional data subsets for the dataset 122.

In some embodiments, the first LLM 154 and the second LLM 158 may perform one or more operations based on the first group and the second group, respectively, in parallel. For instance, the first LLM 154 and the second LLM 158 may determine the first adjusted dataset 156 and the second adjusted dataset 160 at the same time. In other embodiments, the first LLM 154 and the second LLM 158 may operate in a serial order. For instance, the first LLM 154 may perform the operations before the second LLM 158. While FIG. 1C illustrates two LLMs, any suitable number of LLMs may be used.

In some embodiments, the first adjusted dataset 156 and the second adjusted dataset 160 may be combined with the dataset 152 to generate an adjusted dataset 162. The adjusted dataset 162 may include the dataset 122 and the additional data subsets included in the first adjusted dataset 156 and the second adjusted dataset 160.

FIG. 2 illustrates a flowchart of an example method 200 including operations to be performed by a computing system for adjusting a dataset with respect to ID-style values, in accordance with one or more embodiments of the present disclosure. The method 200 may be performed by any suitable system, apparatus, or device. For example, the method 200 may be implemented using the system 100 of FIG. 1A or the system 120 of FIG. 1B. Although illustrated with discrete blocks, the steps and operations associated with one or more blocks of the method 200 may be divided into additional blocks, combined into fewer blocks, or eliminated, depending on the particular implementation.

The method 200 may include block 202. At block 202, one or more data subsets of a dataset may be identified. The data subsets may be identified based on an analysis of the dataset. The dataset may be an example of the dataset 102 of FIG. 1. In these and other embodiments, the data subsets may be identified in response to each of the data subsets including a percentage of the values in the data subsets that are considered unique values, satisfying a threshold. The values may be considered unique in instances in which the values are not repeated within a given data subset. For example, a data subset may include different identifiers for classes in a school such as PSY101, PSY102, PSY103, and PSY104 in which no identifier is assigned to more than one class. In these and other embodiments, a data subset may be considered unique in response to a threshold percentage of values within the data subset being unique. In some instances, the threshold percentage may be determined as a predetermined number. For instance, the threshold percentage may be predetermined as 80% or 90%. In other instances, the threshold percentage may be determined using one or more algorithms. For instance, a ML model may be trained to determine which data subsets may be considered as unique for including unique values.

In some embodiments, the one or more data subsets with a high percentage of unique values may be represented in ID-style values. The ID-style values may be considered ID-style, in which the values within a same data subset shares a consistent format or structures. For instance, continuing the example of identifiers for different classes, the values in the data subset may be represented in [subject] [level] format (e.g., [PSY] [101] where PSY represents psychology and 101 represents lowest level). In some instances, the ID-style values may include numerical IDs and/or alphanumeric IDs in which the values include at least one numerical value.

At block 204, one or more data subsets may be selected from identified data subsets. For instance, the identified data subsets may be analyzed to determine whether the identified data subsets include independent and identically distributed (IID) values. Independent values may be characterized as the occurrence or value of an individual value does not affect the occurrence or value of another individual value. Values may be considered as being identically distributed in instances in which the values follow the same probability distribution. The IID values may be values that are independent from each other and drawn from the same probability of distribution. For example, test scores from multiple classes may be IID. For instance, the test scores are determined independent from each other, and the scores for each class may be drawn from the same distribution.

In some embodiments, in response to determining that the one or more data subsets are not IID, the one or more data subsets may be kept for adjusting the dataset. At block 208, the data of the selected data subsets may be analyzed to determine whether the selected data subsets include semantically meaningful data. In these and other embodiments, the semantically meaningful data may refer to data that carries significance or conveys meaningful content in a particular context. For instance, the semantically meaningful data may be interpreted using actual meaning of words, phrases, and/or terms included in the data. For example, an individual value of a data subset may include a character string “HIST101.” The individual value may be semantically meaningful, as “HIST” may represent a word or string of characters that has an understood meaning in context by itself, namely “history.” Moreover, if the column name “Course ID” is considered, the individual value “HIST101” may be more likely to be determined to be semantically meaningful.

In some embodiments, determination of whether an individual data subset of the selected data subsets is semantically meaningful may be determined using an LLM. For instance, one or more LLM prompts may be generated. The LLM prompts may direct the LLM to determine whether the one or more individual values of the individual data subset are semantically meaningful. In some embodiments, a sample set of individual values may be provided to the LLM, in LLM prompts, instead of all of the individual values of the individual data subset. Providing the sample set of individual values may reduce the time taken to determine whether the individual data subset is semantically meaningful. In some embodiments, the column name may be carried in the prompts as well to allow the LLM to make a better prediction.

In these and other embodiments, the sample set of individual values may be randomly selected from the individual values of the individual data subset. In some embodiments, the values in the sample set may be inspected to remove any duplicated values. For instance, any individual value that is included more than once in the sample set may be detected and removed from the sample set. In response to determining no duplication existing in the sample set, the individual values of the sample set may be provided to the LLM, as part of one or more prompts, to determine whether the individual values are semantically meaningful.

In some embodiments, responses from the LLM may provide a first list of individual values that are semantically meaningful and a second list of individual values that are not semantically meaningful. In these and other embodiments, a number of individual values in the first list and the second list may be determined. In some embodiments, the LLM may be prompted to provide the number of individual values in the first list and the second list along with the first list and the second list.

In some embodiments, a number of semantically meaningful values (e.g., the number of individual values in the first list) may be compared against a number of individual values that are not semantically meaningful (e.g., the number of individual values in the second list) to determine whether the individual data subset is semantically meaningful as a whole. In some embodiments, the individual data subset may be semantically meaningful in instances in which there are more (at least by one) individual values that are semantically meaningful than the individual values that are not semantically meaningful in the sample set. In some instances, the number of individual values in the sample set may be set as an odd number, excluding 1, to eliminate possible instances of having a same number of individual values that are semantically meaningful and the individual values that are not semantically meaningful. In other embodiments, a threshold percentage of the individual values may need to be determined as semantically meaningful for the individual data subset to be semantically meaningful.

In response to determining the one or more data subsets as being semantically meaningful, LLM clustering may be performed with respect to the one or more data subsets at block 210. The LLM clustering may include grouping one or more individual values of an individual data subset into one or more clusters that may share one or more characteristics. In such instances, each individual values of the individual data subset may be embedded using the LLM to be represented in embeddings or vectors. For instance, the embeddings may include numerical representations of words, sentences, and/or phrases. The embeddings may be created by encoding textual information into high-dimensional vectors in a continuous space. The individual values may be clustered based on a similarity between the embeddings and each cluster may be assigned a unique categorical ID. As an example, the individual values may be related to course IDs for different courses (e.g., courses at a college). Each course may be associated with a course ID that represents the course. The course ID may include two parts: a first part indicating the field of study (e.g., “PSY” for psychology, “HIST” for history, etc.), and a second part indicating level of the course (e.g., 101 for lowest level, 102 for higher level, etc.). In such instances, the individual course IDs in the same field of study (e.g., courses IDs starting with “PSY”) may be grouped together into a cluster. Moreover, since semantic information is considered by the LLM for clustering, similar courses may be grouped together into a cluster. For example, “ENG” and “ESL” which are English courses and English-as-a-Second-Language courses, may be grouped into a cluster. In such instances, a new data subset may be generated indicating the cluster IDs corresponding to the individual values.

In some instances, in which the one or more data subsets are not semantically meaningful, a data division rule for the individual values of the one or more data subsets may be determined using the LLM at block 212. For instance, the individual values may be divided into two or more divided values. In some embodiments, the process of determining the division rule using the LLM may be described in further detail with respect to FIG. 3 of the present disclosure.

In these and other embodiments, syntax clustering with respect to the divided values may be performed at block 214. For instance, similarly split values may be grouped together into a new data subset. For example, a first value of a first data subset may read “B4064600,” and a second value of the first data subset may read “B4064900”. A division rule may divide the first value into “B” and “4064600”, and the second value into “B” and “4064900”. In such instances, the two “B” s may be clustered together into a second data subset and “4064600” and “4064900” may be clustered together into a third data subset. In these and other embodiments, the second data subset and the third data subset may not have been part of the dataset.

At block 216, new data subsets may be added to the dataset. For example, the second and third data subsets may be added to the dataset. As another example, the new data subset generated using the LLM clustering at block 210 may also be added to the dataset. In some embodiments, the first data subset that was used to create the second data subset and the third data subset may be replaced by the second data subset and the third data subset. In other embodiments, the second data subset and the third data subset may be added in addition to the first data subset.

Modifications, additions, or omissions may be made to the method 200 without departing from the scope of the present disclosure. For example, the outlined steps and operations are only provided as examples, and some of the steps and operations may be optional, combined into fewer steps and operations, or expanded into additional steps and operations without detracting from the essence of the disclosed embodiments.

For example, the new data subsets may be analyzed to detect any exceptions. For instance, the new data subsets may include individual values that do not conform to a format or structure of the data subset. For example, individual values of a new data subset may correspond to a number. In some instances, a particular individual value may include an exceptional value that differs from other individual values. For example, the particular individual value may include a special character along with a number (e.g., 10+). In such instances, the particular individual value may be addressed such that the format of the exceptional values is adjusted to the same format as the other individual values in the data subset (e.g., 10). In some embodiments, the adjusting of the exceptional values may be performed using the LLM. For instance, a prompt may be generated for each exceptional value to command the LLM to adjust the format of the exceptional value. The response of the LLM may be used to replace the exceptional value such that the particular individual value conforms to the format of the data subset.

FIG. 3 illustrates a flowchart of an example method 300 of determining a data division rule, in accordance with one or more embodiments of the present disclosure. In some embodiments, the method 300 may illustrate different steps of the block 212 of FIG. 2. The method 300 may be performed by any suitable system, apparatus, or device. For example, the method 300 may be implemented using the system 100 of FIG. 1A or the system 120 of FIG. 1B. Although illustrated with discrete blocks, the steps and operations associated with one or more blocks of the method 300 may be divided into additional blocks, combined into fewer blocks, or eliminated, depending on the particular implementation. The method 300 may be performed with respect to one or more data subsets of a dataset that include non-semantically meaningful data, such as the data subsets determined with respect to block 208 of FIG. 2.

The method 300 may include block 302. At block 302, one or more values of a data subset may be provided to a LLM as part of a LLM prompt. The LLM prompt may command the LLM to divide the individual values of the data subsets. For instance, the LLM prompt may command the LLM to divide each individual value of the one or more values into two or more meaningful substrings. In some embodiments, a random number of individual values may be provided to the LLM for the division instead of the entire data subset which may improve the time taken by the LLM.

At block 304, a data division rule may be determined based on responses of the LLM. For instance, the responses of the LLM may provide two or more substrings for each individual value provided to LLM in the LLM prompts. In these and other embodiments, a pattern of division may be determined based at least on how the substrings were generated. For instance, the responses may be analyzed to determine a pattern of division among the substrings provided by the LLM. Some examples of the pattern of division may include alphabet/numeric division (e.g., “XLY101” to “XLY” and “101”), special character division (e.g., “Kepler-10a” to “Kepler” and “10a”), and specific index division (e.g., “B10c3748” to “B” and “10c3748”; and “C67d7922” to “C” and “67d67922”). In some embodiments, the pattern of division for the data subset may be determined based on a threshold number of divided individual values sharing the same pattern of division. For example, a majority (e.g., more than half) of the divided individual values sharing the same pattern of division.

At block 306, the determined data division rule may be applied to all individual values of the individual data subset. For instance, the same pattern of division may be applied to each of the individual values, such that the entire data subset is divided following a same pattern. In some instances, the substrings of the individual values divided following the same pattern may be grouped together into sets of substrings.

At block 308, it may be determined whether a quality of the determined data division rule is sufficient for training a ML model. For instance, the sets of substrings may be analyzed to determine whether each set of substrings may be meaningful in training a ML model. For instance, each set of substrings may be considered as a new data subset and be analyzed to determine whether the set of substrings is relevant for the ML model. The set of substrings may be relevant where the substring is complete (e.g., includes enough information), accurate (e.g., no errors, missing values, outliers), diverse (e.g., covers diverse scenarios and situations), etc. For instance, a set of substrings may not be considered meaningful in which the substrings in the set are constant (e.g., one value for the all substrings), includes large percentage of missing values, and/or are highly correlated to other substrings in the set. In such instances, the set of substrings or the new data subset may not provide additional information to the ML model such that dividing the data subset is meaningful.

In response to determining that the data division rule does not provide data sufficient for training the ML model, the determined division rule may be discarded and the LLM may be prompted to divide the individual values of the subset of data in a different manner again at block 310. In these and other embodiments, returning to block 304, the new substrings may be used to determine a new data division rule. In some embodiments, a loop of discharging a determined data division rule and determining a new data division rule (e.g., a loop of blocks 304, 306, 308, and 310) may be repeated until a sufficient data division rule is determined or a threshold number of loop iterations is satisfied. For instance, the threshold number may be placed on a number of times the loop may be repeated to limit the processing time and/or use of resources.

In response to determining that the quality of the data division rule is sufficient for training the ML model, one or more additional data subsets may be created for the dataset. For instance, the additional data subsets may incorporate the substrings. For example, using the example of specific index division of “B10c3748” and “C67d7922,” “B” and “C” may be grouped together in a first additional data subset and “10c3748” and “67d7922” may be grouped into a second additional data subset.

Modifications, additions, or omissions may be made to the method 300 without departing from the scope of the present disclosure. For example, the outlined steps and operations are only provided as examples, and some of the steps and operations may be optional, combined into fewer steps and operations, or expanded into additional steps and operations without detracting from the essence of the disclosed embodiments.

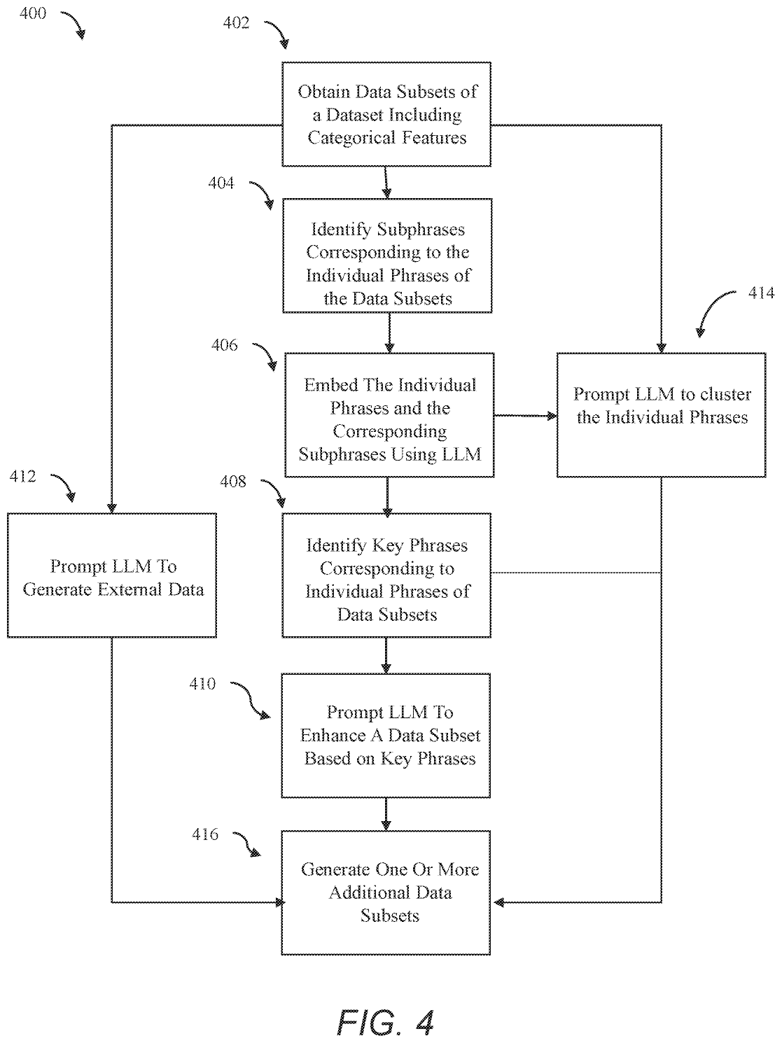

FIG. 4 illustrates a flowchart of another example method 400 of adjusting one or more data subsets of a dataset, in accordance with one or more embodiments of the present disclosure. The method 400 may be performed by any suitable system, apparatus, or device. For example, the method 400 may be implemented using the system 100 of FIG. 1A or the system 120 of FIG. 1B. Although illustrated with discrete blocks, the steps and operations associated with one or more blocks of the method 400 may be divided into additional blocks, combined into fewer blocks, or eliminated, depending on the particular implementation. In some embodiments, the method 400 may be implemented with respect to one or more data subsets of a dataset that include categorial or textual features.

The method 400 may include block 402. At block 402, one or more data subsets of a dataset including textual features may be obtained. For instance, the features or the data subsets of the dataset may be analyzed to determine the data subsets that include textual features, such as described with respect to prompts 126 of FIG. 1B. In such instances, an individual data subset of the one or more data subsets may include multiple individual phrases. In some embodiments, the one or more data subsets may be analyzed to define one or more additional features or data subsets.

At block 404, subphrases of individual phrases of the one or more data subsets may be identified. In some embodiments, the subphrases may include parts of the individual phrases. For instance, the individual phrases may be divided into distinct parts or subphrases. The subphrases may be identified such that each subphrase may independently have a meaning. For example, an individual phrase may be “ABC University of XYZ.” In such instances, the subphrases may include “ABC,” “University,” and “XYZ,” in which each subphrase has an independent meaning. In response to determining two or more subphrases, the subphrases may be compared with the corresponding individual phrase to determine similarity between the subphrases and the individual phrase. For instance, the contextual meaning of the subphrases may be compared against the contextual meaning of the individual phrases to determine how well the subphrases represent the individual phrase. The subphases that adequately represent the meaning of corresponding individual phrases may be identified as key phrases associated with the individual phrases.

In some embodiments, the comparison between the subphrases and the corresponding individual phrase may be performed using embeddings of the subphrases and the individual phrase. For instance, at block 406, the individual phrases and the subphrases may be embedded using the LLM. In such instances, the embeddings generated by the LLM may include numerical representations of words, sentences, and/or phrases. The embeddings including the numerical representations may be used to compare the subphrases and the corresponding individual phrase.

At block 408, the key phrases corresponding to the individual phrases may be determined based on the embeddings. In some embodiments, the key phrases may be determined based on comparisons between the embeddings corresponding to the individual phrases and the corresponding subphrases. For instance, the individual phrase and each subphrase may be compared to identify one or more subphrases that adequately represent the individual phrase.

In some instances, the similarities may be determined using cosine similarity. For instance, the cosine similarity between the embeddings corresponding to the individual phrase and each of the subphases may be determined. In some instances, the subphrases with the highest cosine similarities may be identified as the key phrases. For instance, a certain number of subphrases may be selected as the key phases in a descending order of cosine similarities. In some instances, the certain number may be predetermined. For instance, the top ten subphrases may be selected as the key phrases. As an example of comparing the subphrases and the corresponding individual phrase, continuing the example above, “ABC” may be embedded, “University” may be embedded, “XYZ” may be embedded, and “ABC University of XYZ” may be embedded. The cosine similarity between embeddings corresponding to “ABC” and “ABC University of XYZ”, between “University” and “ABC University of XYZ,” and between “XYZ” and “ABC University of XYZ” may be calculated. In some instances, the cosine similarity between embeddings corresponding to “ABC” and “ABC University of XYZ” and between “University” and “ABC University of XYZ” may satisfy the threshold while the cosine similarity between “XYZ” and “ABC University of XYZ” may not, indicating that “ABC” and “University” represent “ABC University of XYZ” better than “XYZ.”

In some embodiments, the key phrases may be directly used to generate additional data subsets. For instance, at block 416, additional data subsets corresponding to the sets of subphrases may be determined. For example, continuing the example above, “ABC” may be considered as being in a first additional data subset, “University” may be placed in a second additional data subset, and “XYZ” may be placed in a third additional data subset at block 416. Other individual phrases in the data subset may be divided into subphrases following the same division pattern (e.g., [school name], [school type], and [location]). In some instances, an individual phrase may not include all three parts. For example, the subphrase may say “DEF University” without the location. In such instances, a portion of the third additional data subset corresponding to “DEF University” may be left empty or missing.

At block 410, the LLM may be prompted to enhance at least one data subset based on the key phrases. For instance, the key phrases may be used to generate one or more prompts for the LLM. In some embodiments, the one or more prompts may be generated using the prompt template. In some embodiments, the one or more prompts may command the LLM to generate responses including external data. The external data may be defined as data that is not previously included in or could be derived from the dataset. For instance, the LLM may be prompted to generate new data that is related, but not included, in the data of the dataset. For example, continuing the above example, “ABC” and “University” or a combination thereof (e.g., “ABC University”) may be used to generate a prompt. As an example, a prompt template selected from multiple prompt templates may read “What type of schools is [key phrase]” in which case the prompt may read “What type of school is ABC University.” The LLM may use external data not included in the dataset to determine that “ABC University is a private school.” Such prompt may be generated for each of the individual phrases included in a data subset.

At block 416, the responses (e.g., “ABC University is a private school.”) from the LLM may be used to generate one or more data subsets. For example, the responses may indicate the types of schools for different schools included in a particular data subset. In such instances, the responses may be used to generate a new data subset representing the types of schools.

In some embodiments, the individual phrases may be used to generate one or more prompts for the LLM without determining the key phrases. For instance, at block 412, the LLM may be prompted to generate new data from the individual phrases based on external data known the LLM. For instance, the individual phrases may be plugged into the prompt templates to generate new data. For example, instead of the prompt reading “What type of school is ABC University,” the prompt may read “What type of school is ABC University of XYZ.” The response from the LLM may be used to generate one or more additional data subsets at block 416.

In some embodiments, clustering technique may be used to define at least one additional data subset from the one or more data subsets. In some embodiments, the clustering technique may be similar to the clustering technique performed with respect to semantically meaningful data in block 210 of FIG. 2. For instance, one or more individual phrases of an individual data subset may be grouped into one or more clusters that share one or more characteristics. In some embodiments, the clustering may be performed using an LLM. For instance, one or more prompts for an LLM may be generated to command the LLM to group the one or more individual phrases into one or more clusters based on shared characteristics. For example, individual phrases of a data subset may each correspond to a name of a school. In some instances, the individual phrases may be grouped alphabetically.

In some embodiments, the clustering technique may be implemented with respect to the embeddings. For instance, in response to determining the embeddings at block 406, the LLM may be prompted to cluster the individual phrases based on the embeddings corresponding to the individual phrases at block 414, similar to the process taken in block 210 of FIG. 2.

In some embodiments, the clustering technique at block 414 may be implemented with respect to the individual phrases instead of the embeddings. For instance, in response to obtaining the data subsets of the dataset at block 402, the individual phrases of the data subsets may be clustered at block 414.

In some embodiments, the responses from the LLM may be used to generate the additional data subsets. For instance, the one or more clusters that the individual phrases are assigned may be used to generate an additional data subset at block 416.

For example, in some embodiments, the individual phrases may be grouped based on location of the schools. For instance, the LLM may be prompted to determine the location of the schools corresponding to the individual phrases of the data subset and to group the individual phrases into one or more clusters based on locations (e.g., states, regions, etc.). In some embodiments, the individual phrases may be grouped based on any other shared characteristics.

Modifications, additions, or omissions may be made to the method 400 without departing from the scope of the present disclosure. For example, the outlined steps and operations are only provided as examples, and some of the steps and operations may be optional, combined into fewer steps and operations, or expanded into additional steps and operations without detracting from the essence of the disclosed embodiments.

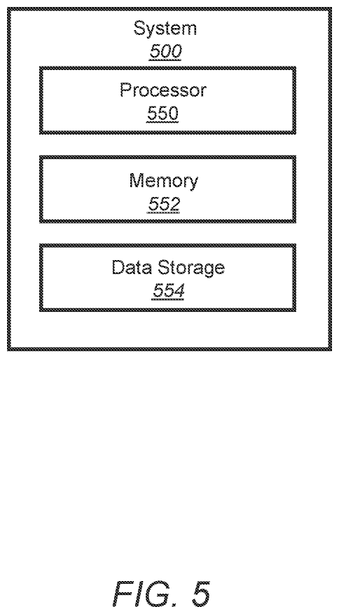

FIG. 5 illustrates a block diagram of an example computing system 500, according to at least one embodiment of the present disclosure. The computing system 500 may be configured to implement or direct one or more suitable operations described in the present disclosure. For example, the computing system 500 may be configured to perform one or more blocks of the method 200 of FIG. 2, the method 300 of FIG. 3 and the method 400 of FIG. 4. For instance, the computing system 500 may be configured to generate prompts for the LLM. The computing system 500 may include a processor 550, a memory 552, and a data storage 554. The processor 550, the memory 552, and the data storage 554 may be communicatively coupled.

In general, the processor 550 may include any suitable special-purpose or general-purpose computer, computing entity, or processing device including various computer hardware or software modules and may be configured to execute instructions stored on any applicable computer-readable storage media. For example, the processor 550 may include a microprocessor, a microcontroller, a digital signal processor (DSP), an application-specific integrated circuit (ASIC), a Field-Programmable Gate Array (FPGA), or any other digital or analog circuitry configured to interpret and/or to execute program instructions and/or to process data. Although illustrated as a single processor in FIG. 5, the processor 550 may include any number of processors configured to, individually or collectively, perform or direct performance of any number of operations described in the present disclosure. Additionally, one or more of the processors may be present on one or more different electronic devices, such as different servers.

In some embodiments, the processor 550 may be configured to interpret and/or execute program instructions and/or process data stored in the memory 552, the data storage 554, or the memory 552 and the data storage 554. In some embodiments, the processor 550 may fetch program instructions from the data storage 554 and load the program instructions in the memory 552. After the program instructions are loaded into memory 552, the processor 550 may execute the program instructions.

The memory 552 and the data storage 554 may include computer-readable storage media for carrying or having computer-executable instructions or data structures stored thereon. By way of example, and not limitation, such computer-readable storage media may include tangible or non-transitory computer-readable storage media including Random Access Memory (RAM), Read-Only Memory (ROM), Electrically Erasable Programmable Read-Only Memory (EEPROM), Compact Disc Read-Only Memory (CD-ROM) or other optical disk storage, magnetic disk storage or other magnetic storage devices, flash memory devices (e.g., solid state memory devices), or any other non-transitory storage medium which may be used to carry or store particular program code in the form of computer-executable instructions or data structures and which may be accessed by a general-purpose or special-purpose computer. In these and other embodiments, the term “non-transitory” as explained in the present disclosure should be construed to exclude only those types of transitory media that were found to fall outside the scope of patentable subject matter in the Federal Circuit decision of In re Nuijten, 500 F.3d 1346 (Fed. Cir. 2007).

Combinations of the above may also be included within the scope of computer-readable storage media. Computer-executable instructions may include, for example, instructions and data configured to cause the processor 550 to perform a certain operation or group of operations.

Modifications, additions, or omissions may be made to the computing system 500 without departing from the scope of the present disclosure. For example, in some embodiments, the computing system 500 may include any number of other components that may not be explicitly illustrated or described.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, it may be recognized that changes may be made in form and detail without departing from the scope of the present disclosure. Thus, the present disclosure is limited only by the claims.

In some embodiments, the different components, modules, engines, and services described herein may be implemented as objects or processes that execute on a computing system (e.g., as separate threads). While some of the systems and methods described herein are generally described as being implemented in software (stored on and/or executed by general purpose hardware), specific hardware implementations or a combination of software and specific hardware implementations are also possible and contemplated.

In accordance with common practice, the various features illustrated in the drawings may not be drawn to scale. The illustrations presented in the present disclosure are not meant to be actual views of any particular apparatus (e.g., device, system, etc.) or method, but are merely idealized representations that are employed to describe various embodiments of the disclosure. Accordingly, the dimensions of the various features may be arbitrarily expanded or reduced for clarity. In addition, some of the drawings may be simplified for clarity. Thus, the drawings may not depict all of the components of a given apparatus (e.g., device) or all operations of a particular method.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A method comprising:
accessing a dataset including a plurality of data subsets, each of the data subsets corresponding to a feature of the dataset;
analyzing data in one of the data subsets to determine a characteristic of the data;
selecting a prompt template from among a plurality of prompt templates for the one of the data subsets based on the determined characteristic of the data of the one of the data subsets;
generating a plurality of large language model prompts using the prompt template and the data from the one of the data subsets;
providing the plurality of large language model prompts to a large language model, the plurality of large language model prompts commanding the large language model to perform one or more operations with respect to the data of the one of the data subsets; and
creating one or more additional data subsets for the dataset based on responses of the large language model, each of the one or more additional data subsets corresponding to a new feature of the dataset.

2. The method of claim 1, further comprising:
training a machine learning (ML) model using the dataset; and
performing one or more operations using the ML model.

3. The method of claim 1, wherein the data from the one of the data subsets includes character strings and the plurality of large language model prompts include dividing each of the character strings into two or more sub-strings, wherein the one or more additional data subsets are created using the two or more sub-strings.

4. The method of claim 3, wherein a portion of the data of the one of the data subsets is provided to the large language model, the method further comprising:
determining a string division rule based on the responses of the large language model; and
dividing a remaining portion of the data of the one of the data subsets into two or more sub-strings using the string division rule.

5. The method of claim 4, wherein the method further comprises:
determining whether a quality of the string division rule is sufficient for a machine learning model; and
in response to determining the string division rule is not sufficient for the machine learning model, determining a new string division rule.

6. The method of claim 1, wherein the plurality of large language model prompts includes clustering the data of the one of the data subsets, the method further comprising assigning an identifier for each cluster identified by the response of the large language model, wherein the one or more additional data subsets includes information regarding the clusters.

7. The method of claim 1, wherein the plurality of large language model prompts are provided to the large language model in parallel.

8. The method of claim 1, further comprising replacing the one of the data subsets with one of the one or more additional data subsets.

9. The method of claim 1, wherein data from the one of the data subsets is text data and the plurality of large language model prompts include requesting additional information regarding the text, wherein the one or more additional data subsets include the additional information from the large language model.

10. The method of claim 1, wherein data from the one of the data subsets is text data, wherein the one or more additional data subsets include information regarding subphrases of individual phrases in the data subsets.

11. The method of claim 1, further comprising:
identifying an exception in the one of the data subsets, the exception including individual data values being in different format from other data values in the one of the data subsets;
selecting a second prompt template from among the plurality of prompt templates for the exception based on one or more characteristics of the exception;
generating a second large language model prompt using the second prompt template and the exception;
providing the second large language model prompt to the large language model to generate a second response; and
replacing the exception in the one of the data subsets based on the second response.

12. One or more non-transitory computer-readable media storing instructions that, when executed by one or more processors, cause a system to perform operations, the operations comprising:
accessing a dataset including a plurality of data subsets, each of the data subsets corresponding to a feature of the dataset;
analyzing data in one of the data subsets to determine a characteristic of the data;
selecting a prompt template from among a plurality of prompt templates for the one of the data subsets based on the determined characteristic of the data of the one of the data subsets;
generating a plurality of large language model prompts using the prompt template and the data from the one of the data subsets;
providing the plurality of large language model prompts to a large language model, the plurality of large language model prompts commanding the large language model to perform one or more operations with respect to the data of the one of the data subsets; and
creating one or more additional data subsets for the dataset based on responses of the large language model, each of the one or more additional data subsets corresponding to a new feature of the dataset.

13. The one or more non-transitory computer-readable media of claim 12, the operations further comprising:
training a machine learning (ML) model using the dataset; and
performing one or more operations using the ML model.

14. The one or more non-transitory computer-readable media of claim 12, wherein the data from the one of the data subsets includes character strings and the plurality of large language model prompts include dividing each of the character strings into two or more sub-strings, wherein the one or more additional data subsets are created using the two or more sub-strings.

15. The one or more non-transitory computer-readable media of claim 14, wherein a portion of the data of the one of the data subsets is provided to the large language model, the operations further comprising:
determining a string division rule based on the responses of the large language model; and
dividing a remaining portion of the data of the one of the data subsets into two or more sub-strings using the string division rule.

16. The one or more non-transitory computer-readable media of claim 15, wherein the operations further comprises:
determining whether a quality of the string division rule is sufficient for a machine learning model; and
in response to determining the string division rule is not sufficient for the machine learning model, determining a new string division rule.

17. The one or more non-transitory computer-readable media of claim 12, wherein the plurality of large language model prompts includes clustering the data of the one of the data subsets, the operations further comprising assigning an identifier for each cluster identified by the response of the large language model, wherein the one or more additional data subsets includes information regarding the clusters.

18. The one or more non-transitory computer-readable media of claim 12, wherein the plurality of large language model prompts is provided to the large language model in parallel.

19. The one or more non-transitory computer-readable media of claim 12, the operations further comprising replacing the one of the data subsets with one of the one or more additional data subsets.

20. A system, comprising:
one or more processors; and
one or more non-transitory computer-readable storage media configured to store instructions that, in response to being executed, cause the system to perform operations, the operations comprising:
obtaining a first waveform profile corresponding to a first optical signal received at a first optical receiver via an optical link;
obtaining a second waveform profile corresponding to a second optical signal received at a second optical receiver via the optical link;
combining the first waveform profile and the second waveform profile to form a combined waveform profile;
obtaining a first reconstructed waveform profile that is an estimate of the first waveform profile and a second reconstructed waveform profile that is an estimate of the second waveform profile;
combining the first reconstructed waveform profile and the second reconstructed waveform profile to form a combined reconstructed waveform profile;
determining a power profile estimation corresponding to the optical link based on a comparison between the combined waveform profile and the combined reconstructed waveform profile; and
adjusting one or more aspects of optical transmission over the optical link based on the determined power profile estimation.
